(19) United States
(12) Patent Application Publication
(10) Pub. No.: US 2026/0056225 A1
(43) Pub. Date: Feb. 26, 2026

(54) MICROELECTROMECHANICAL SENSOR COMPONENT AND MICROELECTROMECHANICAL INERTIAL SENSOR

(71) Applicant: Robert Bosch GmbH, Stuttgart (DE)

(72) Inventor: Johannes Classen, Reutlingen (DE)

(21) Appl. No.: 19/270,857

(22) Filed: Jul. 16, 2025

(30) Foreign Application Priority Data
Aug. 22, 2024 (DE) 10 2024 207 997.9

(51) Int. Cl. G01P 15/125

(52) U.S. Cl. CPC G01P 15/125

(57) ABSTRACT

A microelectromechanical sensor component. The microelectromechanical sensor component includes a substrate; a seismic mass connected to the substrate and movable relative to the substrate via a suspension spring, wherein the seismic mass can be deflected in a deflection direction extending perpendicular to the substrate surface; an evaluation electrode arranged between the substrate and the seismic mass for capacitively detecting a deflection of the seismic mass and providing a capacitive useful signal; and a reference electrode having a plurality of reference electrode portions which form a reference electrode frame surrounding the seismic mass at least in portions. The reference electrode is anchored to the substrate by at least two attachment points and each reference electrode portion in a self-supporting manner between two attachment points. A reference counter electrode is arranged between the substrate and the reference electrode for providing a capacitive reference signal in cooperation with the reference electrode.

### CROSS REFERENCE

The present application claims the benefit under 35 U.S. C. § 119 of German Patent Application No. DE 10 2024 207 997.9 filed on Aug. 22, 2024, which is expressly incorporated herein by reference in its entirety.

### FIELD

The present invention relates to a microelectromechanical sensor component. The present invention further relates to a microelectromechanical inertial sensor.

### BACKGROUND INFORMATION

Certain microelectromechanical sensor components and microelectromechanical inertial sensors are described in the related art. Microelectromechanical systems are also abbreviated as MEMS.

To detect accelerations, microelectromechanical sensor components can comprise a substrate and a seismic mass that can be deflected relative to the substrate, the deflection of which can be capacitively detected by means of an evaluation electrode. Depending on the design of the microelectromechanical sensor components, these can be configured to detect a deflection of the seismic mass of the sensor component parallel to a substrate surface of the substrate and/or perpendicular to the substrate surface. To detect deflections of the seismic mass perpendicular to the substrate surface, corresponding sensor components can, which are also referred to as z-acceleration sensor components based on the three-dimensional spatial axis designations x, y, z, various measuring principles are used. For example, the seismic mass can be designed as a rocker structure with asymmetrically designed rocker arms and suspended by means of a torsion spring over two mutually spaced evaluation electrodes that can capacitively detect a deflection of a rocker arm from a rest position. In addition, it is also known to arrange a seismic mass via suspension springs in a translationally movable manner above an evaluation electrode, such that the seismic mass does not experience a tilting movement during a deflection, but rather a translational displacement away from or toward the substrate surface. An example of such a sensor component with a translationally movable seismic mass perpendicular to the substrate surface can be found, for example, in U.S. Pat. No. US 6,892,576 B2. In order to allow for a differential evaluation of the capacitance change associated with a translational deflection of the seismic mass, it can be the case that a so-called top electrode is arranged on a side of the seismic mass facing away from the evaluation electrode or a reference electrode is arranged between the substrate and a substantially immovably anchored part of the seismic mass.

### SUMMARY

According to the present invention, a microelectromechanical sensor component is provided. According to an example embodiment of the present invention, the microelectromechanical sensor component including a substrate having a substrate surface, a seismic mass connected to the substrate and movable relative to the substrate via a suspension spring, wherein the seismic mass can be deflected in a deflection direction extending perpendicular to the substrate surface, and an evaluation electrode arranged between the substrate and the seismic mass for capacitively detecting a deflection of the seismic mass and providing a capacitive useful signal, wherein the microelectromechanical sensor component further comprises a reference electrode having a plurality of reference electrode portions which form a reference electrode frame surrounding the seismic mass at least in portions, wherein the reference electrode is anchored to the substrate by at least two attachment points and a reference electrode portion in each case extends in a self-supporting manner between two attachment points, and wherein the microelectromechanical sensor component has a reference counter electrode arranged between the substrate and the reference electrode for providing a capacitive reference signal in cooperation with the reference electrode.

In simple terms, it is provided to surround the seismic mass with a reference electrode on multiple, in particular all, lateral sides for differential capacitive evaluation in order to provide a particularly accurate reference signal taking into account any mechanical stress effects on the sensor component during its operation and thereby ensure high offset stability during signal evaluation. For example, mechanical stress on the sensor component can lead to local or extensive substrate deformations, which can cause a change in the basic distance between the evaluation electrode and the seismic mass. Such a change in distance may result in a corresponding offset of the useful signal of the evaluation electrode. If the seismic mass is surrounded by the reference electrode, substrate deformations also affect reference electrode portions in the affected regions, and therefore the reference signal also experiences a corresponding change and the offset of the useful signal can be at least approximately compensated for with the reference signal change. Thus, the differential signal between the useful signal and the reference signal remains small when mechanical stress occurs and the sensor component is comparatively offset-stable. In other words, a local stress-dependent adjustment of the reference electrode level can be obtained by mechanical interaction of the reference electrode with the substrate surface. By designing the reference electrode as a reference electrode frame, the microelectromechanical sensor component can be designed compactly and the proposed influence of the differential capacitive evaluation can still be implemented effectively. The reference electrode can be arranged in the same functional layer as the seismic mass, whereby manufacturing-related offset effects can be reliably avoided, especially compared to a top electrode that is at a distance.

According to an example embodiment of the present invention, a microelectromechanical sensor component can, for example, be a component that is produced with semiconductor technology and has mechanical and electrical microstructures. A microelectromechanical sensor component can be suitable for implementation as a system-on-chip (SoC) due to its microstructural design. As a sensor component, the microelectromechanical sensor component can be configured to detect physical quantities. The sensor component described in this application can be configured in particular for the direction-dependent detection of a translational acceleration as a physical quantity.

The substrate can be a flat semiconductor carrier structure. The substrate can be a silicon wafer, for example. The substrate has a substrate surface on a front side and a back surface on an opposite back side. The front side of the substrate can form an active side of the substrate on which the mechanical and electrical microstructures of the sensor component are arranged.

According to an example embodiment of the present invention, the seismic mass is connected to the substrate and is movable relative to the substrate via a suspension spring. A seismic mass can be a mechanical structure of the sensor component that is configured to interact with the physical quantity to be detected, in particular the acceleration force, and by means of deflection can cause a capacitive signal change at the evaluation electrode that is representative of the physical quantity. The seismic mass can be anchored to the substrate via one or more connection points. For example, the seismic mass can be deflected from a defined rest position, such that a deflection of the seismic mass relative to the rest position can be used to detect the physical quantity. The movability of the seismic mass is achieved using one or in particular a plurality of suspension springs, it being possible to predetermine the degrees of freedom of the seismic mass by means of a suitable spring design. The suspension spring can be secured by a first spring end to the substrate at a connection point of the seismic mass and by a second spring end to the movable seismic mass.

According to an example embodiment of the present invention, the seismic mass can be deflected in a deflection direction substantially perpendicular to the substrate surface. In simple terms, the seismic mass can be designed to move toward and away from the substrate surface. In particular, the seismic mass can be deflected translationally in the deflection direction described above. Compared to rocker structures, translationally deflectable seismic masses are associated with reduced mechanical noise, also referred to as Brownian noise, since not only an asymmetric mass portion but the entire movable seismic mass contributes to the mechanical sensitivity of the microelectromechanical sensor component. Thus, a good signal-to-noise ratio of the microelectromechanical sensor component can be achieved with a translationally displaceable seismic mass.

According to an example embodiment of the present invention, the microelectromechanical sensor component further comprises an evaluation electrode arranged between the substrate and the seismic mass for capacitively detecting a deflection of the seismic mass and for providing a capacitive useful signal. The evaluation electrode can be an electrically conductive, stationary electrode element that is substantially immovably secured to the substrate. The evaluation electrode can be spaced apart from the substrate and electrically insulated by an insulating layer, for example an oxide layer. The evaluation electrode can be connected to an electrical conductor track system of the microelectromechanical sensor component, which in turn can be electrically connected to an evaluation circuit. The evaluation electrode can in particular extend under a movable portion of the seismic mass. The evaluation electrode can be arranged at a distance from the mechanical connection points of the seismic mass.

According to an example embodiment of the present invention, the microelectromechanical sensor component further comprises a reference electrode having a plurality of reference electrode portions. The reference electrode is used to provide a capacitive reference signal in cooperation with the reference counter electrode in order to allow for an evaluation of the useful signal and reference signal so as to form a differential overall signal. With a differential evaluation, a more accurate detection of the physical quantity is possible, independent of, for example, fluctuating environmental conditions, manufacturing tolerances and mechanical stress effects in the sensor component. The reference electrode is essentially immobile. In other words, the reference electrode does not react with a deflection when an acceleration force is applied. The reference electrode portions frame the seismic mass at least in portions, thus surrounding it on multiple, in particular all, lateral sides of the seismic mass. A lateral side of the seismic mass can be understood as a side of the seismic mass that does not coincide with a bottom side facing the substrate surface or a top side facing away from the substrate surface, but rather is present on an outer surface connecting the top side and the bottom side. In particular, the lateral surfaces of the seismic mass may extend substantially perpendicular to the substrate surface. A reference electrode frame surrounding the seismic mass at least in portions can include the reference electrode frame being either continuous or interrupted, as will be explained in connection with corresponding embodiments. The reference electrode is anchored to the substrate by at least two attachment points. By carefully selecting the number and placement of the reference electrode attachment points, it can be ensured that mechanical stress acts in a similar way on changes in distance at the reference capacitor as at the evaluation capacitor, i.e., below the seismic mass. Thus, a differential signal as the difference between the useful signal and the reference signal remains small when mechanical stress occurs or, in other words, the sensor is comparatively offset-stable. The attachment points can constitute a local fastening of the reference electrode without further degrees of freedom, such that the reference electrode is immovably connected to the substrate. In this case, the reference electrode portion is a region of the reference electrode that extends in a self-supporting manner between two attachment points. Accordingly, the reference electrode portions can be designed like bridges. If there is a substrate deformation in a substrate region in which an attachment point is present, the substrate deformation is at least approximately transferred to the self-supporting part of the reference electrode portion, such that there can be locally different distances between the reference counter electrode and the reference electrode, leading to a changed reference signal. The reference signal change can at least approximately compensate for a useful signal change due to local changes in the distance between the seismic mass and the evaluation electrode caused by the substrate deformation. Since the reference electrode is predominantly self-supporting above the substrate, if substrate warping occurs due to mechanical stress, not only a basic distance between the evaluation electrode and the seismic mass will change, but also, at least in some regions, a basic distance between the reference electrode and the reference counter electrode. Since the reference electrode surrounds the seismic mass in a frame-like manner, very different forms of substrate warping can occur, for example with regard to different directions and combinations thereof as well as with regard to different orders of substrate warping, for example quadratic or cubic, without resulting in serious offset changes. The effects of the substrate warping can thus be compensated for with respect to an offset signal. The attachment points of the reference electrode can be selected to match the geometry of the seismic mass, a chip and/or a housing used in order to implement the microelectromechanical component sensor. In principle, there is a high degree of design freedom in the choice of the aspect ratio in the sense of a ratio between the length and width of the reference electrode as well as with regard to a position and number of mechanical connection points of the seismic mass, with regard to a geometry and number of suspension springs and with regard to a size and position of the evaluation electrode.

According to an example embodiment of the present invention, the reference counter electrode can be an electrically conductive, stationary electrode element that is substantially immovably secured to the substrate. The reference counter electrode can be spaced apart from the substrate and electrically insulated by an insulating layer, for example an oxide layer. The reference counter electrode can be connected to an electrical conductor track system of the microelectromechanical sensor component, which in turn can be electrically connected to an evaluation circuit.

According to one example embodiment of the present invention, the reference electrode portions can be designed and arranged in the microelectromechanical sensor component in such a way that an average change in distance, caused by mechanical stress in the sensor component, between the evaluation electrode and the seismic mass relative to a rest position of the seismic mass corresponds to an average change in distance between the reference counter electrode and the reference electrode with a maximum deviation of 25%. This allows for a very good compensation result for a stress-related useful signal change by means of a corresponding reference signal change. In particular, the reference electrode portions can be designed and arranged in the microelectromechanical sensor component in such a way that the average change in distance between the evaluation electrode and the seismic mass corresponds to the average change in distance between the reference counter electrode and the reference electrode with a maximum deviation of 15%, in particular 5%. Ideally, the average change in distance between the evaluation electrode and the seismic mass and the average change in distance between the reference counter electrode and the reference electrode can be the same. An average change in distance can correspond to a sum of considered changes in distance along the evaluation electrode or the reference electrode divided by the number of considered changes in distance. In order to achieve such ratios between the average changes in distance, various component-specific parameters must be taken into account, for example with regard to geometry, dimensioning, material properties, conductor track system, chip, package and circuit board design as well as other conditions and variables of the microelectromechanical sensor component implemented, for example, in an inertial sensor that influence any mechanical stress on the sensor component. In order to ascertain a suitable design and arrangement of the reference electrode portions in order to achieve comparable average changes in distance in the regions of the seismic mass and the reference electrode, calculations, simulation models or practical tests, for example, can be carried out on the basis of the specific product specifications.

According to one example embodiment of the present invention, the reference electrode portions can extend parallel to outer edges of the seismic mass. This allows mechanical stress effects along the seismic mass to affect the reference electrode in a comparable manner, such that reference signal changes can be obtained that can substantially correspond to the available useful signal changes. The outer edges of the seismic mass refer to a lateral outer boundary of the seismic mass, which can define a contour of the seismic mass, for example a rectangular or square contour, in a plane parallel to the substrate surface. A parallel extension of the reference electrode portions can be understood in particular to mean that a relevant longitudinal extension of the reference electrode portions, which can correspond to a greatest extension direction of a reference electrode portion parallel to the substrate surface, extends parallel to an outer edge of the seismic mass. In addition, it can be the case in particular that the reference electrode portions extend at a predefined distance parallel to the nearest outer edge of the seismic mass in each case. Such a predefined distance can, for example, be smaller than a width extension of an associated reference electrode portion extending parallel to the substrate surface and perpendicular to the longitudinal extension.

According to one example embodiment of the present invention, a capacitively effective electrode area of the reference electrode can correspond to a capacitively effective electrode area of the evaluation electrode with a maximum deviation of 10%. In particular, a capacitively effective electrode area of the reference electrode can correspond to a capacitively effective electrode area of the evaluation electrode with a maximum deviation of 5%. Ideally, the capacitively effective electrode areas of the reference electrode and the evaluation electrode can be the same. This makes it possible to minimize an offset of the overall signal from the differential evaluation of the useful signal and the reference signal. In simple terms, by appropriately matching the electrode areas to one another, the aim is to ensure that, in a rest position of the seismic mass, a detected reference signal value substantially corresponds to a detected useful signal value, such that in the ideal case, only a representative overall signal is available when the seismic mass is deflected. If there is a plurality of evaluation electrode portions, the capacitively effective electrode area of the evaluation electrode can correspond to the sum of the individual capacitively effective electrode areas of the evaluation electrode portions. The capacitively effective electrode area of the reference electrode can correspond to the sum of the individual capacitively effective electrode areas of the reference electrode portions.

According to one example embodiment of the present invention, the reference electrode portions can form a continuous reference electrode frame. In other words, the reference electrode can surround the seismic mass without interruption. The reference electrode portions can therefore form a closed reference electrode frame. A continuous reference electrode frame has the advantages of simple production and a large reference electrode area in order to achieve a pronounced reference signal. In addition, a comparatively large component area potentially affected by mechanical stress can be used to influence the reference signal. According to one possible embodiment, the reference electrode portions can extend along an entire outer edge length of the seismic mass parallel to the outer edges.

According to one example embodiment of the present invention, the reference electrode portions can form a reference electrode frame that is interrupted in portions. In other words, the reference electrode can surround the seismic mass only in portions, at least one interruption in the sense of a free space being provided between two reference electrode portions. The reference electrode portions can therefore form an open reference electrode frame. A reference electrode frame interrupted in portions can, for example, have the advantage of a reduced effective electrode area if a comparatively small evaluation electrode is present and the capacitively effective electrode areas are to be adjusted to one another as described above. In addition, for example, a conductor track feedthrough to the evaluation electrode without electrical parasitic capacitances can be made possible by an interruption in the reference electrode frame. Furthermore, the reference electrode portions are mechanically decoupled from one another to a greater degree, such that stress effects caused by local deformation of the reference electrode can be detected in a spatially limited manner. According to one possible embodiment, the reference electrode portions can extend parallel to outer edge portions of the seismic mass, free outer edge portions being provided without a parallel extending reference electrode portion.

According to a further development of the present invention, the interrupted reference electrode frame can have at least one interruption on a long side between two corner regions of the reference electrode frame. A corner region can be understood as a portion of the reference electrode frame at which a first part of a reference electrode portion transitions at an angle, in particular at a right angle, into a second part of the reference electrode portion, or at which a first reference electrode portion transitions at an angle, in particular at a right angle, into a second reference electrode portion, an attachment point of the reference electrode being arranged between the first and the second reference electrode portion. The corner regions of the reference electrode frame can be connected to one another by straight long sides. If an interruption of the reference electrode frame is provided on such a long side, a conductor track can be easily fed through to the evaluation electrode without electrical parasitic capacitances. In addition, for example, an angled reference electrode frame part can be present between two interruptions provided on different long sides, which frame part has two mutually perpendicular main extension directions parallel to the substrate surface and can thus react precisely to multi-dimensional mechanical stress effects, in particular substrate deformations, with a change in distance. According to one possible embodiment, at least one interruption can be provided on each long side.

Alternatively or additionally, according to a further development of the present invention, the interrupted reference electrode frame can have at least one interruption in a corner region of the reference electrode frame. For example, a gap can be provided between two reference electrode portions guided at right angles to one another. In particular, the interruption can be so pronounced that the interrupted corner region of the reference electrode frame as such is omitted, i.e., an angled transition between reference electrode portions or between parts of a reference electrode portion is completely omitted. According to one possible embodiment, at least one interruption can be provided at each corner region. If all corner regions of the reference electrode frame are eliminated in this way, only straight reference electrode portions are present along the long sides of the seismic mass. Such a geometrically simplified reference electrode frame is easy to produce and can, if desired, provide favorable mechanical decoupling of the reference electrode portions.

According to one example embodiment of the present invention, the reference electrode can have at least four attachment points. This ensures a particularly stable attachment of the reference electrode to the substrate. With, for example, four or eight attachment points, a favorable symmetry of the arrangement with respect to an x-and y-axis parallel to the substrate surface can be ensured. The attachment points can, for example, be evenly distributed over the reference electrode frame such that the reference electrode portions extending between the attachment points can have the same capacitively effective individual electrode areas.

According to one example embodiment of the present invention, the reference electrode can have a maximum of eight attachment points. This ensures that sufficient self-supporting reference electrode portions with a capacitively effective reference electrode area are available and can be used to compensate for stress-related useful signal changes of the evaluation electrode. The maximum of eight attachment points can be regularly distributed. In particular, if the seismic mass has a rectangular or square basic shape, two attachment points of the reference electrode can be provided on each long side of the seismic mass. The two attachment points per long side can divide the reference electrode frame on the long side into three equal portions or can be moved more towards a center of the reference electrode extending in particular parallel to the outer edge of the seismic mass, such that a middle portion there is smaller than the two outer portions of the reference electrode. In such an arrangement, if substrate warping occurs, the changes in distance in the corner regions of the reference electrode frame can be smaller than in an arrangement with one attachment point arranged centrally on the long side, since the change in distance increases with increasing lateral distance from the attachment points. Depending on the specific design of the microelectromechanical sensor component with regard to material, geometry and dimensioning of the sensor component structures as well as on an environment of the sensor component, for example a chip, package or circuit board, different compensation effects can be adjusted in a targeted manner by varying the placement of the attachment points.

According to one example embodiment of the present invention, the reference electrode can have a maximum of two attachment points. This provides a reference electrode with a particularly extensive capacitively effective reference electrode area, such that a pronounced reference signal is obtainable and, if the capacitively effective electrode areas of the reference electrode and of the evaluation electrode are matched, the evaluation electrode can also be designed with a correspondingly large area to obtain a pronounced useful signal. A reference electrode having two attachment points can be advantageous, for example, if the sensor component and/or a chip on which the sensor component is arranged and/or a housing in which the sensor component is installed has an elongate shape, since then significantly different stress-induced effects can occur in the direction of the x-axis than perpendicular thereto in the direction of the y-axis.

According to one example embodiment of the present invention, at least one attachment point can be arranged in a corner region of the reference electrode frame. This allows for the creation of a stable reference electrode frame with a favorable mechanical interaction with the substrate surface for local stress-dependent adjustment of the reference electrode level. According to one possible embodiment, an attachment point can be provided in each corner region of the reference electrode frame.

According to one example embodiment of the present invention, at least one attachment point can be arranged on a long side between two corner regions of the reference electrode frame.

This makes it possible, for example, to focus on angled reference electrode portions in order to better represent multidimensional stress or bending effects with the mechanically reacting reference electrode portions. In addition, the production of such an attachment point can be made easier because there is no need to pay particular attention to a particularly precise arrangement of the attachment point in an angled corner region.

According to one example embodiment of the present invention, the evaluation electrode can have a regular cross shape. The evaluation electrode can, for example, have four symmetrically arranged cross arms. The cross arms can extend between mechanical connection points that anchor the seismic mass to the substrate. The cross arms can, for example, extend to attachment points of the reference electrode frame. The evaluation electrode can be aligned centrally below a movable region of the seismic mass. The cross shape can be point and/or axially symmetric. With an evaluation electrode having a regular cross shape, a microelectromechanical sensor component with a metrologically favorable electrode shape can be provided, which allows for uniform detection of a deflection of the seismic mass in different spatial directions and the capacitively effective electrode area of which can be easily adapted to a capacitively effective electrode area of the reference electrode.

According to a further development of the present invention, the evaluation electrode can have an extension portion formed on the regular cross shape. For example, a cross arm can transition into a transverse arm at its end facing away from the center of the cross shape. The evaluation electrode can be formed symmetrically with the extension portion, for example by two opposing cross arms having congruently shaped transverse arms such that a geometric shape of the evaluation electrode can be divided into two congruent mirror image halves along an axis of symmetry extending through the center of the cross shape. By means of an extension portion, the capacitively effective electrode area of the evaluation electrode can be easily adapted to the capacitively effective electrode area of the reference electrode. In addition, a more pronounced useful signal can be achieved by the larger electrode area compared to the cross shape with favorable area utilization, for example when mechanical connection points of the seismic mass prevent the spread of the cross arms. Furthermore, an extension portion can also advantageously be used to capacitively monitor elongate seismic masses that have a rectangular basic shape with a greater length than width.

According to one example embodiment of the present invention, the seismic mass can have at least two recesses, at least one attachment point of the reference electrode being arranged in each recess of the seismic mass. Accordingly, the attachment points of the reference electrode can be spatially relocated into an inner region of the seismic mass via attachment arms extending from the reference electrode frame in the direction of a geometric center of the seismic mass. Due to the recesses in the seismic mass, it can be divided into movable mass wings, starting from a geometric center of the seismic mass, which extend between the recesses. The evaluation electrode can have a basic shape adapted to such mass wings, for example cross arms with arm diameters that widen outward in the direction of the reference electrode frame. The seismic mass can be connected to the substrate via a connection point in its geometric center and suspension springs extending therefrom. The proposed arrangement allows for a compact, centered mechanical attachment of the seismic mass and the reference electrode with a high degree of movability of the seismic mass and a protected arrangement of the anchoring attachment and connection points.

According to one example embodiment of the present invention, the suspension spring can be designed such that the seismic mass can be deflected in deflection directions extending perpendicular and parallel to the substrate surface, the microelectromechanical sensor component having at least one lateral sensing element for detecting a deflection of the seismic mass parallel to the substrate surface. A lateral sensing element can be understood as a capacitively effective sensing structure, for example, which cannot detect a change in distance between the seismic mass and the evaluation electrode, but can detect a lateral deflection of the seismic mass from a rest position. By appropriately designing the suspension spring, in which, for example, a specific spring shape provides a specifically reduced spring stiffness in a given spatial direction for a corresponding deflectability of the seismic mass along the given spatial direction, the degrees of freedom of the seismic mass can be precisely specified.

According to a further development of the present invention, the seismic mass can be deflected in three mutually perpendicular spatial directions, the microelectromechanical sensor component having at least two lateral sensing elements which are configured to detect a deflection of the seismic mass along two mutually perpendicular spatial directions parallel to the substrate surface. This can advantageously widen the scope of application of the sensor component and increase the functional density on the occupied chip area in a system-on-chip implementation of the sensor component. Accordingly, the microelectromechanical sensor component can be configured to capacitively detect accelerations in all three-dimensional spatial axis directions. By means of suitable spring geometries and by adding lateral sensing elements for detection along an x-axis and a y-axis, the sensor component can be extended to a three-axis sensor component. This is particularly advantageous, since the seismic mass acts in all three spatial directions simultaneously in a manner that reduces mechanical noise. In comparison to a side-by-side arrangement of three single-axis sensor elements on a chip, the same noise performance can thus be achieved on a substantially smaller surface area, or a significantly better noise performance can thus be achieved if the same total surface area is assumed.

According to one example embodiment, at least one lateral sensing element can have an electrode comb structure formed by ground electrode fingers arranged on the seismic mass and counter electrode fingers arranged parallel to the ground electrode fingers on the substrate. In particular, all lateral sensing elements can have such an electrode comb structure. An electrode comb structure in which ground electrode fingers and counter electrode fingers engage in the interstices of the respective other electrode fingers in a comb-like manner allows for a simple lateral sensing element that is suitable for the precise detection of a lateral deflection movement.

The present invention also relates to a microelectromechanical inertial sensor having a microelectromechanical sensor component according to one of the above-described features and having a signal processing unit for applying and processing signals of the microelectromechanical sensor component. The microelectromechanical inertial sensor can also achieve the above-described advantages of a compact design, high offset stability and an improved signal-to-noise ratio. The microelectromechanical inertial sensor can be designed as an acceleration sensor for detecting a translational acceleration and, for example, by combining the above-described microelectromechanical sensor component with a rotation rate sensor component, can additionally be designed as a rotation rate sensor for detecting a rotational acceleration. The microelectromechanical inertial sensor can be configured, in particular, to detect an acceleration in a vertical spatial direction with a deflection of the seismic mass perpendicular to the substrate surface. Due to the high offset stability of the microelectromechanical sensor component, an inertial sensor with high measurement accuracy and high measurement sensitivity can be realized according to the proposed features. A signal processing unit can have an evaluation circuit, which can be designed in particular as an integrated circuit, for example as an ASIC (application-specific integrated circuit). The signal processing unit is configured to apply and/or process signals of the microelectromechanical sensor component and can, for example, be used to receive and evaluate sensor signals of the microelectromechanical sensor component and to perform control tasks.

The microelectromechanical sensor component of the present invention can advantageously be integrated with a, for example, three-axis rotation rate sensor element and/or further, in particular three-axis acceleration sensor elements on a common MEMS chip, in a common housing or in a common terminal device. In particular, the microelectromechanical sensor component, the rotation rate sensor element and/or the further acceleration sensor element can be integrated on one and the same chip since, unlike in the case of rocker designs, very small electrode gaps are not needed to achieve very low noise values. The same electrode gaps as for the rotation rate sensor element and/or the further acceleration sensor elements can therefore be used in the microelectromechanical sensor component. This facilitates process integration, since the realization of electrode gaps of different sizes would mean considerable additional effort in the manufacture of the inertial sensor.

According to one example embodiment of the present invention, the microelectromechanical inertial sensor can be designed to detect structure-borne sound, in particular bone conduction, and/or airborne sound. Due to a high measurement sensitivity and due to the small installation space occupied, even very weak sound waves can be reliably detected with the inertial sensor. In particular, the microelectromechanical sensor component of the inertial sensor can be designed to detect bone conduction, it being possible to provide a particularly offset-stable and low-noise bone conduction detector on account of the design of the sensor component with the proposed features and according to the optional embodiments. Due to its compact design and high measurement sensitivity, the microelectromechanical inertial sensor is advantageously suitable for use close to the body, allowing for comfortable and reliable bone conduction detection. Such bone conduction detection can, for example, be advantageously used in modern wireless earphones or headsets. For example, the signals of the sensor component that detects bone conduction can be offset against simultaneously recorded microphone signals, for example to allow for active noise suppression. If the microelectromechanical sensor component is used in combination with further sensor elements, the above-described sensor component can, for example, be used as a bone conduction sensor, while the further sensor element can be used for activity detection or rotation rate detection, for example for 3D audio applications.

The use of the above-described microelectromechanical sensor component and/or the inertial sensor of the present invention can be particularly advantageous if the reduction of noise has a particularly high priority in a z-acceleration sensor. The microelectromechanical sensor component according to the above-described features can ensure a very good signal-to-noise ratio while at the same time providing advantageous offset performance.

The described microelectromechanical sensor component and/or the described microelectromechanical inertial sensor of the present invention can be used, for example, in the automotive and/or consumer sectors, for example in miniaturized hearables such as earphones, earbuds or true wireless stereo headsets.

The described microelectromechanical sensor component and/or the described microelectromechanical inertial sensor of the present invention can be used, for example, in connection with smartphones and tablets, wearables, hearables, smart glasses, smart contact lenses, augmented reality, virtual reality, drones, gaming, toys, robots, the smart home and, for example, in an industrial context, amongst other things for the following further applications: wake-up functions for selected device modules, detection of device orientation, screen orientation and display orientation, detection of a significant movement, shock and free-fall detection; HMI (human-machine interface) functionality, e.g., multi-tap detection, activity, gesture and context recognition, bone conduction detection, user recognition, voice recognition, keyword recognition; movement control, Cardan system, height and position stabilization, flight control, image stabilization, indoor and outdoor navigation, floor recognition, position tracking and route recording, PDR (pedestrian dead reckoning), dynamic route planning, detection of boundaries and obstacles, indoor SLAM (simultaneous localization and mapping); intrusion monitoring, real-time movement recognition and tracking, activity tracking, pedometer, calorie counter, sleep monitoring; detection of the wearing state of hearables (in-ear/out-of-ear detection), determination of head orientation and head movement; logistics, parts tracking, energy management and energy-saving measurement, predictive maintenance; sensor data fusion.

The present invention can furthermore be used in connection with automobile applications, e.g., with regard to: crash detection, e.g., in airbag systems; electronic stability programs (ESP), vehicle dynamics control (VDC); hill start assist, hill hold control (prevention of rolling back when starting off on inclines); adaptive chassis control; smart tires, e.g., road condition monitoring, road noise cancellation; navigation applications; autonomous driving; theft detection, alarm functions; monitoring tailgate tilt; optimization of engine control and of the combustion process in gasoline or diesel engines.

The described microelectromechanical sensor component and/or the described microelectromechanical inertial sensor of the present invention can be suitable for production in a semiconductor mass production process due to their fundamentally simple design.

In general, in the context of this application, the words “a/an,” unless expressly defined otherwise, are not to be understood as numerals, but as indefinite articles with the literal meaning of “at least one.”

The present invention allows for various embodiments and is explained in more detail below using exemplary embodiments with the figures.

### BRIEF DESCRIPTION OF THE DRAWINGS

FIG. 1 is a schematic diagram of a microelectromechanical sensor component according to a first example embodiment of the present invention in a plan view.

FIG. 2A shows the microelectromechanical sensor component according to the first embodiment of the present invention in an initial state in a sectional side view along the section line A-B.

FIG. 2B is a schematic diagram of the microelectromechanical sensor component according to the first embodiment of the present invention in a stress state in a sectional side view along the section line A-B.

FIG. 3 is a schematic diagram of the microelectromechanical sensor component according to the first embodiment in an initial state in a sectional side view along the section line C-D;

FIG. 4 is a schematic diagram of a microelectromechanical sensor component according to a second example embodiment of the present invention in a plan view.

FIG. 5 is a schematic diagram of a microelectromechanical sensor component according to a third example embodiment of the presnet invention in a plan view.

FIG. 6 is a schematic diagram of a microelectromechanical sensor component according to a fourth example embodiment of the present invention in a plan view.

FIG. 7 is a schematic diagram of a microelectromechanical sensor component according to a fifth example embodiment of the present invention in a plan view.

FIG. 8 is a schematic diagram of a microelectromechanical sensor component according to a sixth example embodiment of the present invention in a plan view.

FIG. 9 is a schematic diagram of a microelectromechanical sensor component according to a seventh example embodiment of the present invention in a plan view.

FIG. 10 is a schematic diagram of a microelectromechanical inertial sensor having a microelectromechanical sensor component, according to an example embodiment of the present invention.

### DETAILED DESCRIPTION OF EXAMPLE EMBODIMENTS

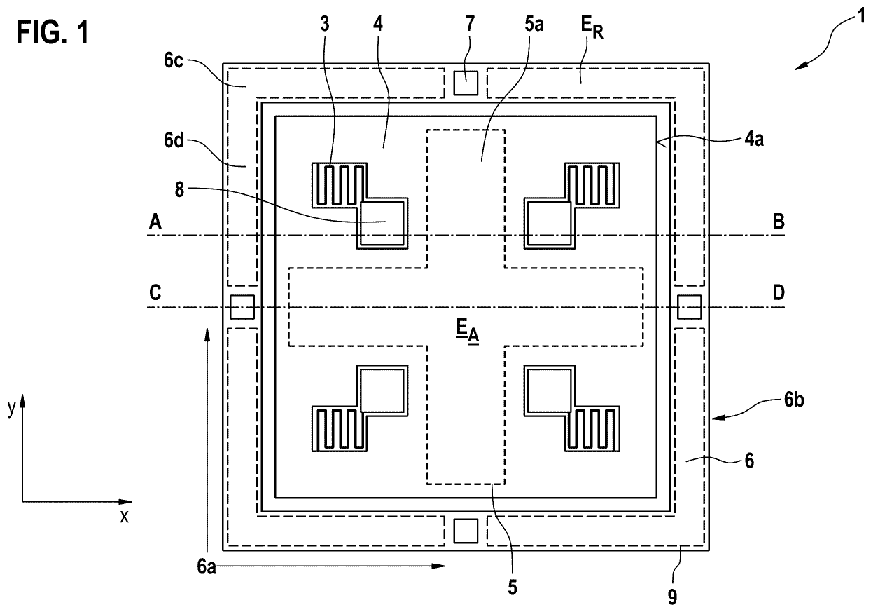

FIGS. 1, 2A, 2B and 3 are schematic representations of a microelectromechanical sensor component 1 in a plan view and sectional side views. According to the exemplary embodiments shown, the microelectromechanical sensor component 1 is configured as an acceleration sensor component.

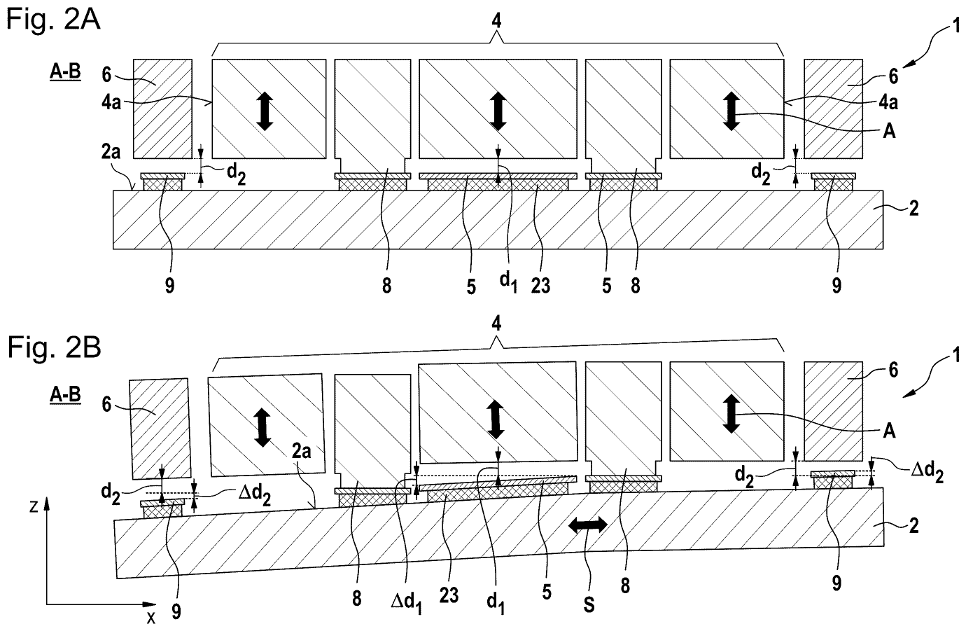

The microelectromechanical sensor component 1 has a substrate 2, for example a silicon wafer, having a substrate surface 2a. FIG. 2A shows the sensor component 1 in an initial state in which, ideally, no mechanical stress effects are present on the sensor component 1. FIG. 2B shows the sensor component 1 in a stress state in which there is warping of the substrate surface 2a due to mechanical stress on the sensor component 1. The associated effects on the sensor component 1 are explained in more detail below.

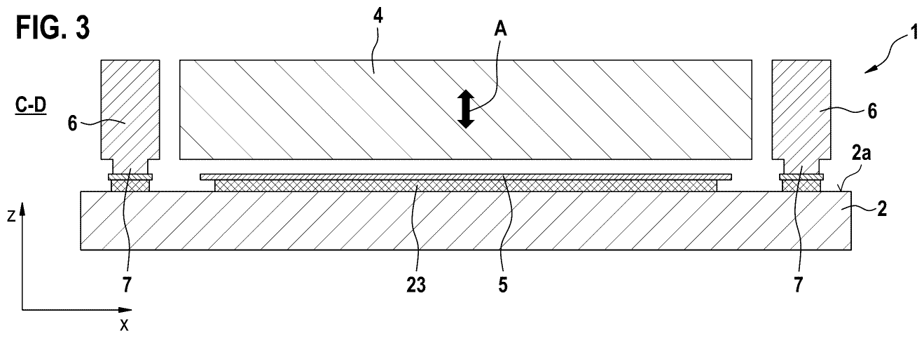

The microelectromechanical sensor component 1 has a seismic mass 4 connected to the substrate 2 and movable relative to the substrate 2 via suspension springs 3. The seismic mass 4 can be deflected translationally along a z-axis of a three-dimensional spatial coordinate system in a deflection direction A extending perpendicular to the substrate surface 2a, as can be seen in FIGS. 2A, 2B and 3. According to the exemplary embodiment shown in FIG. 1, the seismic mass 4 is connected to the substrate 2 via four mechanical connection points 8, such that a favorable symmetry of the arrangement with respect to the x-and y-axes is achieved. The suspension springs 3 are each connected by a first spring end to a mechanical connection point 8 and by a second spring end to the movable seismic mass 4. The seismic mass 4 can have perforation openings (not shown in detail) in order to provide etching access for a production-related etching process and/or to influence damping properties of the microelectromechanical sensor component 1 in a targeted manner.

An evaluation electrode 5 is arranged between the substrate 2 and the seismic mass 4 and is used to capacitively detect a deflection of the seismic mass 4 and to provide a capacitive useful signal from the detected deflection. The evaluation electrode 5 has a regular cross shape 5a and is arranged centrally below the movable seismic mass 4. The cross arms of the evaluation electrode 5 are arranged at a distance from the mechanical connection points 8 of the seismic mass 4 and extend toward the attachment points 7 of a reference electrode frame 6b, which are explained below.

Furthermore, the microelectromechanical sensor component 1 has a substantially immovable reference electrode 6. The reference electrode 6 has a plurality of reference electrode portions 6a which form a reference electrode frame 6b at least surrounding the seismic mass 4, the reference electrode frame 6b shown in FIG. 1 being designed as a continuous reference electrode frame 6b, such that a large electrode area E_{R} is provided and mechanical stress effects are effective over a large electrode distance. As can further be seen in FIG. 1, the reference electrode portions 6a extend parallel to lateral outer edges 4a of the seismic mass 4, thus surrounding them on their lateral sides. The reference electrode 6 is anchored to the substrate 2 by a total of four attachment points 7, as shown in FIG. 1. A reference electrode portion 6a extends in a self-supporting manner between the attachment points 7 in each case. The attachment points 7 are each arranged on a long side 6d between two corner regions 6c of the reference electrode frame 6b. In FIG. 3, a sectional side representation shows that the attachment points 7 are designed for the local anchoring of the reference electrode 6 to the substrate 2.

In addition, the microelectromechanical sensor component 1 has a reference counter electrode 9 arranged between the substrate 2 and the reference electrode 6 for providing a capacitive reference signal in cooperation with the reference electrode 6. As can be seen in FIGS. 2A and 2B, the evaluation electrode 5 and the reference counter electrode 9 are insulated from the substrate 2 by an oxide layer 23. The evaluation electrode 5 and the reference counter electrode 9 are connected to an electrical conductor track system (not shown in detail) of the microelectromechanical sensor component 1.

A reference electrode 6 surrounding the seismic mass 4 in a frame-like manner can provide a reference signal by means of which it is possible to incorporate mechanical stress effects such as substrate deformations into the reference signal, such that changes in distance Δd₁, caused by the stress effects, between the seismic mass 4 relative to the rest position thereof and the evaluation electrode 5 are present to at least a similar extent between the reference electrode 6 and the reference counter electrode 9. As a result, a stress-related offset signal can be compensated for or at least reduced during the differential capacitive evaluation, such that a comparatively offset-stable microelectromechanical sensor component 1 can be provided. Due to the translational deflectability of the seismic mass 4, the microelectromechanical sensor component 1 also exhibits lower mechanical noise than, for example, sensor structures with a rocker design. Furthermore, the frame-like arrangement of the reference electrode 6 provides a compact microelectromechanical sensor component 1 which is comparatively flat compared to sensor structures having a top electrode and by means of which a differential capacitive evaluation is possible.

FIGS. 2A and 2B schematically illustrate the effects of substrate deformation due to mechanical stress effects on the component structures of the microelectromechanical sensor component 1. In FIG. 2A, it can be seen that, in an initial state in which there is no substrate deformation, there is a basic distance d₁ between the evaluation electrode 5 and the seismic mass 4 in a rest position and also a basic distance d₂ between the reference counter electrode 9 and the reference electrode 6. In FIG. 2B, it can be seen that a mechanical stress S can cause warping of the substrate 2, which leads to locally different changes in distance Δd₁ between the evaluation electrode 5 and the seismic mass 4 in a rest position. Because the reference electrode 6 surrounds the seismic mass 4 in a frame-like manner, locally different changes in distance Δd₂ also occur in the regions of the reference electrode 6 between the reference counter electrode 9 and the reference electrode 6, such that a stress-related offset of the useful signal of the evaluation electrode 5 and of the reference signal of the reference counter electrode 9 can be advantageously compensated for using the changed reference signal. The reference electrode portions 6a can in particular be designed and arranged in such a way that an average change in distance Δd₁ caused by the mechanical stress S in the sensor component 1 between the evaluation electrode 5 and the seismic mass 4 relative to a rest position of the seismic mass 4 corresponds to an average change in distance Δd₂ between the reference counter electrode 9 and the reference electrode 6 with a maximum deviation of 25%. In particular, the deviation may be a maximum of 15% or a maximum of 5%. This allows for a very good compensation result for a stress-related useful signal change by means of a corresponding reference signal change. An average change in distance Δd₁, Δd₂ can in each case correspond to a sum of considered changes in distance Δd₁, Δd₂ along the evaluation electrode 5 and the reference electrode 6 divided by the number of considered changes in distance Δd₁, Δd_{2.}

As can be seen in FIG. 1, the reference electrode 6 has a capacitively effective electrode area E_{R} which is the sum of the individual electrode areas E_{R} of the reference electrode portions 6a. Furthermore, the evaluation electrode 5 has a capacitively effective electrode area E_{A} which is represented here as a contiguous electrode area E_{A}. Advantageously, the capacitively effective electrode area E_{R} of the reference electrode 6 corresponds to the capacitively effective electrode area E_{A} of the evaluation electrode 5 with a maximum deviation of 10%. In particular, the deviation may be a maximum of 5%. If the electrode areas E_{A}, E_{R} are matched in terms of area, the useful signal value can correspond to the reference signal value, such that an overall signal which directly represents a deflection of the seismic mass 4 can be obtained in the differential evaluation.

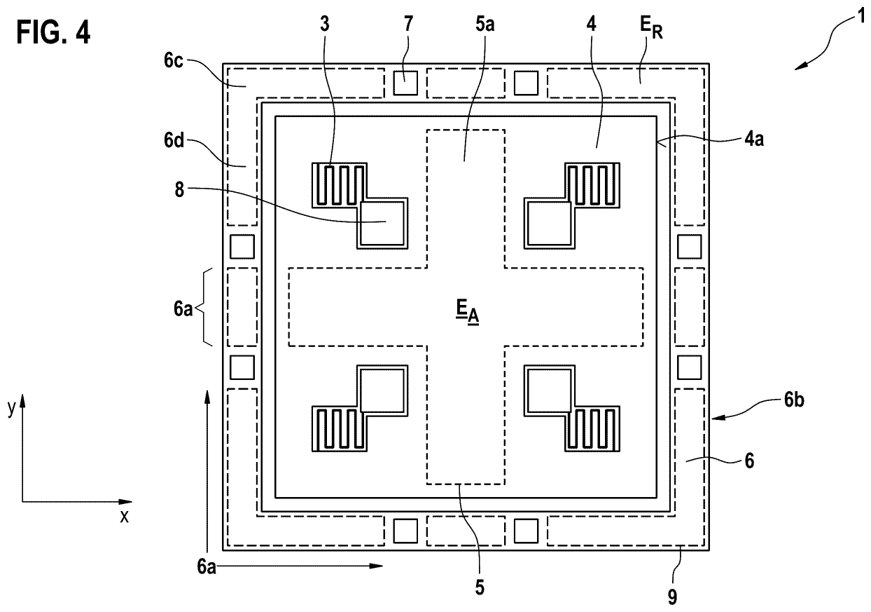

FIG. 4 shows a microelectromechanical sensor component 1 according to a second embodiment. In this embodiment, a total of eight attachment points 7 are provided for anchoring the reference electrode 6 to the substrate 2. Two attachment points 7 are provided on each long side 6d of the seismic mass 4. The two attachment points 7 are arranged closer to a geometric center of the long sides 6d than to the corner regions 6c, such that a central reference electrode portion 6a is smaller than the outer reference electrode portions 6a. This allows the changes in distance Δd₂ in the corner regions 6c of the reference electrode frame 6b to be smaller than in an arrangement with an attachment point 7 arranged centrally on the long side 6c in the event of substrate warping, since the change in distance Δd₂ increases with increasing lateral distance from the attachment points 7.

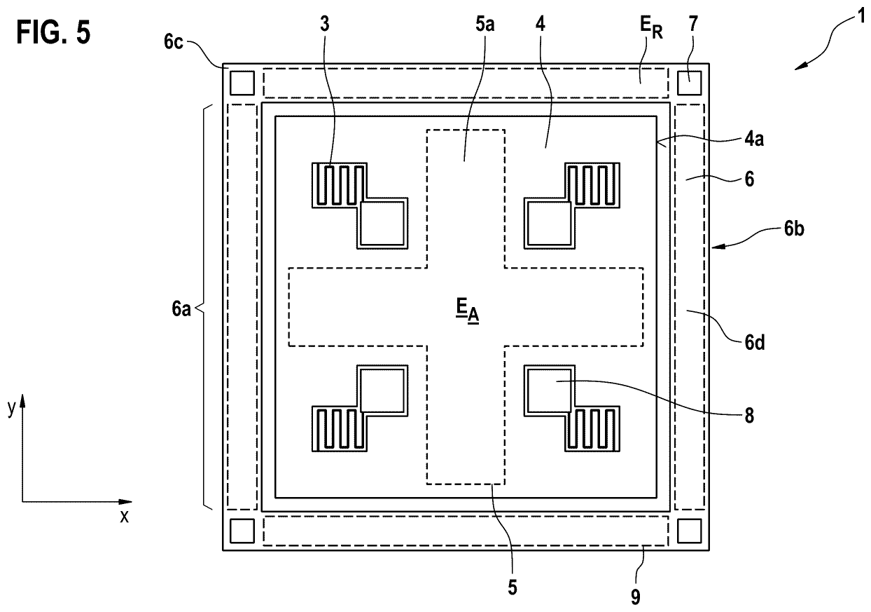

FIG. 5 shows a microelectromechanical sensor component 1 according to a third embodiment. In this embodiment, a total of four attachment points 7 are provided for anchoring the reference electrode 6 to the substrate 2, the attachment points 7, in contrast to the first embodiment shown in FIG. 1, being arranged in the corner regions 6c of the reference electrode frame 6b. This provides a stable reference electrode frame 6b with a favorable mechanical interaction with the substrate surface 2a.

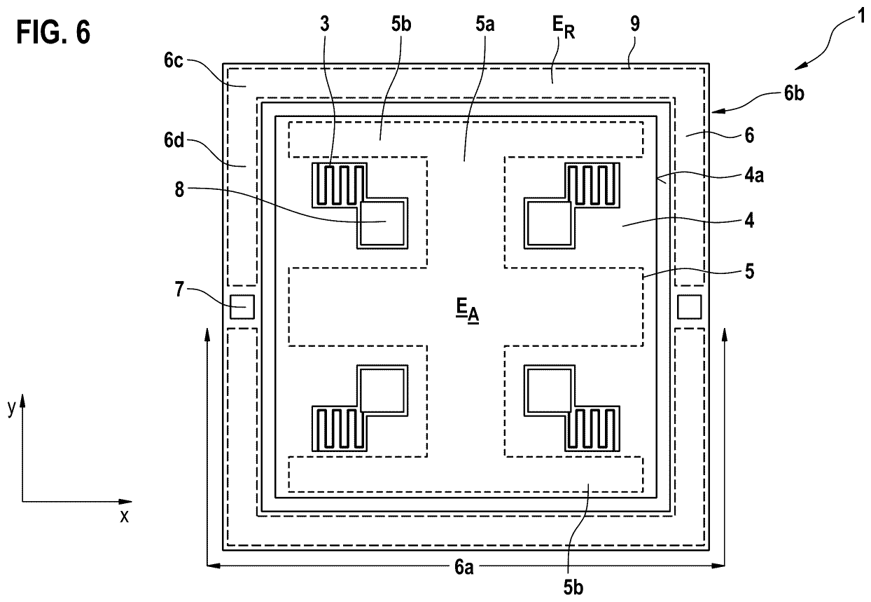

FIG. 6 shows a microelectromechanical sensor component 1 according to a fourth embodiment. In this embodiment, a total of two attachment points 7 are provided for anchoring the reference electrode 6 to the substrate 2. Due to the large electrode area E_{R}, a very pronounced reference signal can be obtained. In addition, the evaluation electrode 5 has an extension portion 5b formed on the regular cross shape 5a. Due to the changed shape of the evaluation electrode 5, larger changes in the useful signal will occur if the substrate 2 is deformed significantly at the upper or lower edge in the image. This can now be better compensated for by also exposing the reference electrode 6 to greater changes in distance Δd₂ in the event of substrate warping. This can be achieved by the more exposed electrode area E_{R} of the reference electrode 6 with the two lateral attachment points 7. Reference electrodes 6 having only two attachment points 7 can advantageously be used in elongate sensor components 1, chips or housings, since then significantly different stress-induced effects can occur in the direction of the x-axis than perpendicular thereto in the direction of the y-axis.

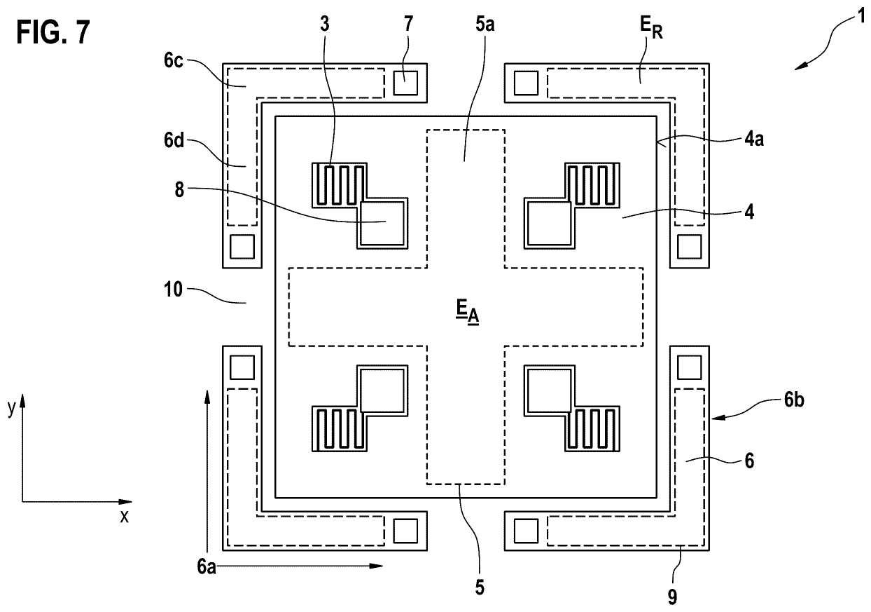

FIG. 7 shows a microelectromechanical sensor component 1 according to a fifth embodiment. In this embodiment, the reference electrode portions 6a form a reference electrode frame 6b which is interrupted in portions and which has an interruption 10 on each long side 6d between the corner regions 6c of the reference electrode frame 6b. Conductor tracks without electrical parasitic capacitances, for example, can be guided through the interruption 10 to the evaluation electrode 5. The angled reference electrode frame parts also allow multidimensional mechanical stress effects to be reliably taken into account. In principle, it is also conceivable, although not shown in more detail, that an interrupted reference electrode frame 6b has at least one interruption 10 in a corner region of the reference electrode frame 6b.

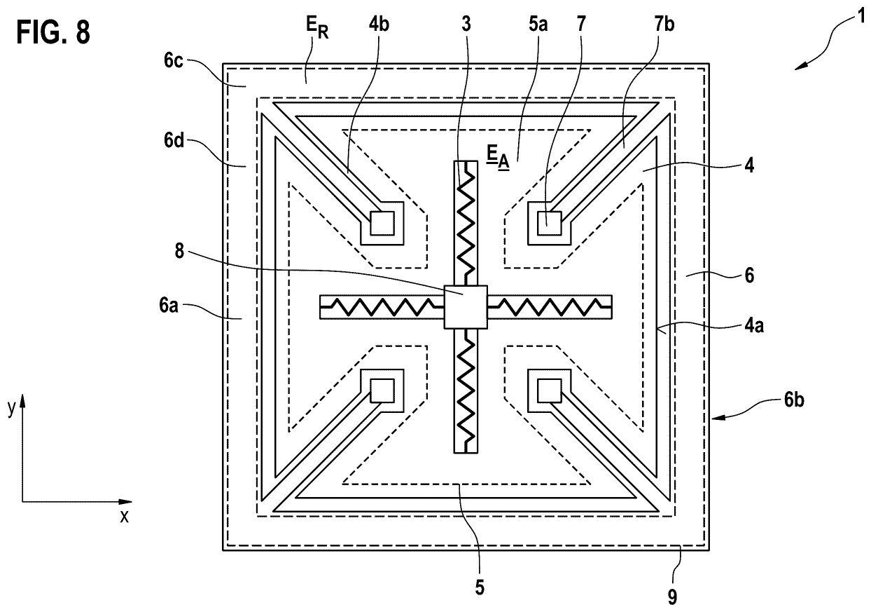

FIG. 8 shows a microelectromechanical sensor component 1 according to a sixth embodiment. In this embodiment, the seismic mass 4 has a plurality of recesses 4b, i.e., a total of four according to the exemplary embodiment shown, an attachment point 7 of the reference electrode 6 being arranged in each recess 4b of the seismic mass 4. The attachment points 7 are laid into an inner region of the seismic mass 4 via connecting arms 7b extending from the reference electrode frame 6b in the direction of a geometric center of the seismic mass 4. The seismic mass 4 is divided by the recesses 4b into movable mass wings that extend between the recesses 4b. The evaluation electrode 5 has a basic shape adapted hereto, in that the cross arms have arm diameters that widen outward in the direction of the reference electrode frame 6b. The seismic mass 4 is connected to the substrate 2 via a single mechanical connection point 8, which is arranged in a geometric center of the seismic mass 4, and suspension springs 3 extending therefrom. With a sensor component 1 according to the sixth embodiment, a compact, centered mechanical attachment of the seismic mass 4 and the reference electrode 6 can be achieved.

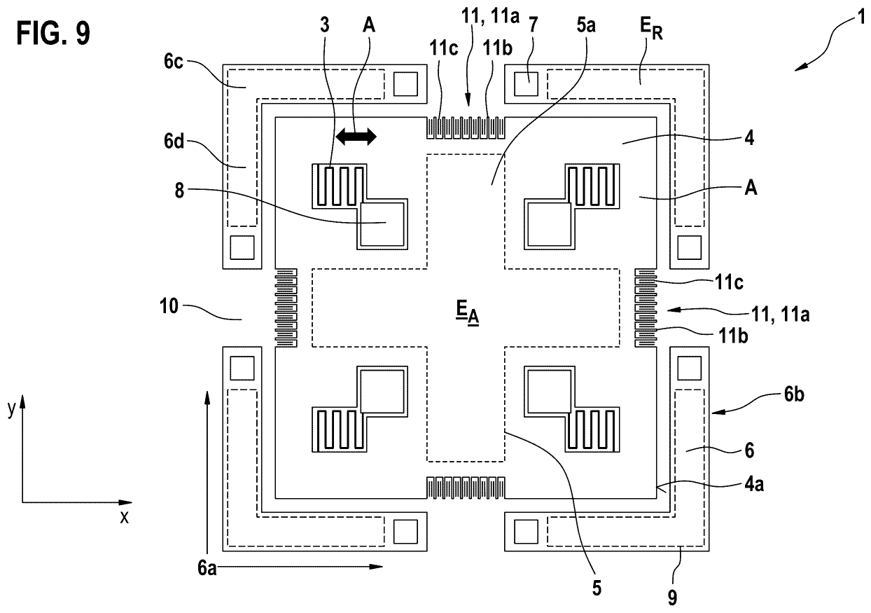

FIG. 9 shows a microelectromechanical sensor component 1 according to a seventh embodiment. In this embodiment, the suspension spring 3 is designed such that the seismic mass 4 can be deflected in deflection directions A extending perpendicular and parallel to the substrate surface 2a. In addition, the microelectromechanical sensor component 1 according to the exemplary embodiment shown has four lateral sensing elements 11 for detecting a deflection of the seismic mass 4 parallel to the substrate surface 2a. Overall, the seismic mass 4 according to the exemplary embodiment shown in FIG. 9 is deflectable in three mutually perpendicular spatial directions x, y, z and the lateral sensing elements 11 are configured to detect a deflection of the seismic mass 4 along two mutually perpendicular spatial directions x, y parallel to the substrate surface 2a. As a result, the microelectromechanical sensor component 1 is designed as a three-axis acceleration sensor element. In this case, the seismic mass 4 can simultaneously reduce the mechanical noise in all three spatial directions x, y, z. As schematically indicated in FIG. 9, the lateral sensing elements 11 each have an electrode comb structure formed by ground electrode fingers 11b arranged on the seismic mass 4 and counter electrode fingers 11c arranged parallel to the ground electrode fingers 11b on the substrate 2, such that a precise detection of lateral deflection movements is possible in a simple manner.

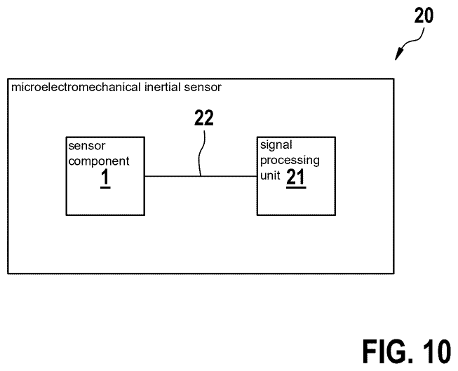

FIG. 10 is a schematic diagram of a microelectromechanical inertial sensor 20 having a microelectromechanical sensor component 1, which is connected via a signal connection 22 to a signal processing unit 21, for example designed as an ASIC, for applying and processing signals of the microelectromechanical sensor component 1. The microelectromechanical sensor component 1 can, for example, be designed according to one of the embodiments described above. The microelectromechanical inertial sensor 20 can, for example, be designed as an acceleration sensor for detecting a translational acceleration. The microelectromechanical inertial sensor 20 can be designed to detect structure-borne sound and/or airborne sound, in particular to detect bone conduction. The microelectromechanical inertial sensor 20 makes it possible to obtain an inertial sensor 20 which is characterized by high offset stability and a favorable signal-to-noise ratio due to the implemented microelectromechanical sensor component 1 according to the described features. Due to its compact design and high sensitivity, reliable and convenient sound detection, for example in wireless earphones or headsets, can be implemented with the microelectromechanical inertial sensor 20.

What is claimed is:

1. A microelectromechanical sensor component, comprising:
a substrate having a substrate surface;
a seismic mass connected to the substrate and movable relative to the substrate via a suspension spring, wherein the seismic mass can be deflected in a deflection direction extending perpendicular to the substrate surface;
an evaluation electrode arranged between the substrate and the seismic mass configured to capacitively detect a deflection of the seismic mass and provide a capacitive useful signal;
a reference electrode including a plurality of reference electrode portions which form a reference electrode frame surrounding the seismic mass at least in portions, wherein the reference electrode is anchored to the substrate by at least two attachment points and each of the reference electrode portions extends in a self-supporting manner between two of the at least two attachment points; and
a reference counter electrode arranged between the substrate and the reference electrode configured to provide a capacitive reference signal in cooperation with the reference electrode.

2. The microelectromechanical sensor component according to claim 1, wherein the reference electrode portions are configured and arranged in the microelectromechanical sensor component in such a way that an average change in distance, caused by mechanical stress in the sensor component, between the evaluation electrode and the seismic mass relative to a rest position of the seismic mass corresponds to an average change in distance between the reference counter electrode and the reference electrode with a maximum deviation of 25%.

3. The microelectromechanical sensor component according to claim 1, wherein the reference electrode portions extend parallel to outer edges of the seismic mass.

4. The microelectromechanical sensor component according to claim 1, wherein a capacitively effective electrode area of the reference electrode corresponds to a capacitively effective electrode area of the evaluation electrode with a maximum deviation of 10%.

5. The microelectromechanical sensor component according to claim 1, wherein the reference electrode portions form a continuous reference electrode frame.

6. The microelectromechanical sensor component according to claim 1, wherein the reference electrode portions form a reference electrode frame that is interrupted in portions.

7. The microelectromechanical sensor component according to claim 6, wherein the interrupted reference electrode frame has at least one interruption on a long side between two corner regions of the reference electrode frame.

8. The microelectromechanical sensor component according to claim 6, wherein the interrupted reference electrode frame has at least one interruption in a corner region of the reference electrode frame.

9. The microelectromechanical sensor component according to claim 1, wherein the reference electrode has at least four attachment points.

10. The microelectromechanical sensor component according to claim 1, wherein the reference electrode has a maximum of eight attachment points.

11. The microelectromechanical sensor component according to claim 1, wherein the reference electrode has a maximum of two attachment points.

12. The microelectromechanical sensor component according to claim 1, wherein at least one attachment point is arranged in a corner region of the reference electrode frame.

13. The microelectromechanical sensor component according to claim 1, wherein at least one of the attachment points is arranged on a long side between two corner regions of the reference electrode frame.

14. The microelectromechanical sensor component according to claim 1, wherein the evaluation electrode has a regular cross shape.

15. The microelectromechanical sensor component according to claim 14, wherein the evaluation electrode has an extension portion formed on the regular cross shape.

16. The microelectromechanical sensor component according to claim 1, wherein the seismic mass has at least two recesses, and wherein at least one attachment point of the reference electrode is arranged in each recess of the seismic mass.

17. The microelectromechanical sensor component according to claim 1, wherein the suspension spring is configured such that the seismic mass can be deflected in deflection directions extending perpendicular and parallel to the substrate surface, and wherein the microelectromechanical sensor component has at least one lateral sensing element configured to detect a deflection of the seismic mass parallel to the substrate surface.

18. The microelectromechanical sensor component according to claim 17, wherein the seismic mass can be deflected in three mutually perpendicular spatial directions, and wherein the microelectromechanical sensor component has at least two lateral sensing elements which are configured to detect a deflection of the seismic mass along two mutually perpendicular spatial directions parallel to the substrate surface.

19. The microelectromechanical sensor component according to claim 18, wherein at least one of the lateral sensing elements has an electrode comb structure formed by ground electrode fingers arranged on the seismic mass and counter electrode fingers arranged parallel to the ground electrode fingers on the substrate.

20. A microelectromechanical inertial sensor, comprising:
a microelectromechanical sensor component, including:
a substrate having a substrate surface,
a seismic mass connected to the substrate and movable relative to the substrate via a suspension spring, wherein the seismic mass can be deflected in a deflection direction extending perpendicular to the substrate surface,
an evaluation electrode arranged between the substrate and the seismic mass configured to capacitively detect a deflection of the seismic mass and provide a capacitive useful signal,
a reference electrode including a plurality of reference electrode portions which form a reference electrode frame surrounding the seismic mass at least in portions, wherein the reference electrode is anchored to the substrate by at least two attachment points and each of the reference electrode portions extends in a self-supporting manner between two of the at least two attachment points, and
a reference counter electrode arranged between the substrate and the reference electrode configured to provide a capacitive reference signal in cooperation with the reference electrode; and
a signal processing unit configured to apply and processing signals of the microelectromechanical sensor component.

21. The microelectromechanical inertial sensor according to claim 20, wherein the microelectromechanical inertial sensor is configured to detect structure-borne sound, the structure-borne sound being bone conduction sound, and/or airborne sound.
